(19) United States
(12) Patent Application Publication
(10) Pub. No.: US 2005/0215249 A1
(43) Pub. Date: Sep. 29, 2005

(54) Systems and methods for wireless communications onboard aircraft

(75) Inventors: John R. Little, Chelmsford (GB); Peter Tuggey, Haywards Heath (GB); Ulf A. Roed, Oslo (NO); Egil Roynestad, Moi (NO)

Correspondence Address: OLIFF & BERRIDGE, PLC, P.O. BOX 19928, ALEXANDRIA, VA, 22320, US

(73) Assignees: ARINC INCORPORATED, Annapolis, MD (US); TELENOR SATELLITE SERVICES, INC., Rockville, MD (US)

(21) Appl. No.: 10/899,096

(22) Filed: Jul. 27, 2004

Related U.S. Application Data
(60) Provisional application No. 60/552,205, filed on Mar. 12, 2004.

(51) Int. Cl. H04Q 7/20

(52) U.S. Cl. 455/431; 455/427; 455/410; 455/12.1

(57) ABSTRACT

A method for communicating between an airborne mobile terminal and a terrestrial location via satellite, whereby a number of encode/decode modules are eliminated from the communications path, thereby reducing the transmission delay and improving the quality of the transmitted voice data.

This non-provisional application claims the benefit of U.S. Provisional Application No. 60/552,205 filed Mar. 12, 2004.

### BACKGROUND OF THE INVENTION

1. Field of Invention

This invention relates to systems and methods for using wireless telephones onboard aircraft.

2. Description of Related Art

Business and leisure travelers increasingly travel with a cell phone, in order to maintain communication with responsibilities at home, and to improve the productivity of the time spent while traveling. However, while traveling by aircraft, cell phone users are unable to communicate with the terrestrial phone network, without first transmitting the voice call through an orbiting satellite of a satellite communications (SATCOM) system. Therefore, a device is needed to interface between the individual cell phone units onboard the aircraft and the satellite communications system.

The current on-board aircraft SATCOM systems defined by an ARINC characteristic ARINC 741, are known as the AES (Aircraft Earth Station) and comprise generally a satellite data unit (SDU), a radio frequency unit (RFU) and a high power amplifier (HPA) required to drive the aircraft antenna. The ARINC 741 standard system also includes modems, transcoders and protocol support for communication with ground earth stations (GESs). The ARINC 741 characteristic defines the form, fit and interfaces whilst the System Definition Manuals (SDMs) released by Inmarsat, of London, England, define the overall functionality of the equipment.

Rockwell Collins SAT-906, for example, is a satellite transceiver unit manufactured by Rockwell Collins of Cedar Rapids, Iowa that meets these standards but other manufacturers such as Honeywell of Morristown, N.J., Thrane & Thrane of Lyngby, Denmark and EMS Technologies of Norcross, Ga. manufacture SATCOM equipment and other compatible equipment conforming to the Inmarsat SDM and/or ARINC 741 standard.

A coding/decoding unit known as a codec performs the bi-directional encoding/decoding of a voice signal into/from a digital signal utilizing complex transformations based on the vocal characteristics of the human voice.

The process of changing from one codec format to another is also known as transcoding.

### SUMMARY OF THE INVENTION

A device is needed to provide an interface between the plurality of mobile terminals onboard the aircraft, and the satellite transceiver unit, such as the Inmarsat SATCOM system. This device should minimize the number of data transcoding events to which the data stream is subjected, in order to reduce delay, and to maintain the quality of the voice communication.

Therefore, it is an object of this invention to provide a communications path between mobile terminals and a ground-based terminal, which communicate via satellite using one or more satellite transceiver units.

Various exemplary embodiments of this invention provide systems and methods for communications via a satellite with a satellite transceiver unit, wherein one or more transcoding encode/decode (codec) units is eliminated from the communications path, thereby reducing delay, improving the quality of the voice transmission, and reducing the cost and complexity of the components of the communications system on-board the aircraft.

Various exemplary embodiments of this invention separately provide systems and methods for communications via a satellite, wherein the satellite transceiver units are operated in a secure telephone mode allowing the transcoder within the AES and GES to be eliminated.

These and other features and advantages of this invention are described in, or are apparent from, the following detailed description of various exemplary embodiments of the systems and methods according to this invention.

### BRIEF DESCRIPTION OF THE DRAWINGS

Various exemplary embodiments of this invention will be described in detail, with reference to the following figures, wherein:

FIG. 1 is an exemplary block diagram of a communications channel between a mobile terminal onboard an aircraft and a ground-based mobile terminal;

FIG. 2 is an exemplary block diagram of an uplink portion of a communications channel between a mobile terminal onboard an aircraft and a ground-based terminal;

FIG. 3 is an exemplary block diagram of a downlink portion of a communications channel between a mobile terminal onboard an aircraft and a ground-based terminal;

FIG. 4 is an exemplary block diagram of an uplink portion of the communications channel, wherein a rate adapter is substituted for the second transcoder according to this invention;

FIG. 5 is an exemplary block diagram of a downlink portion of the communications channel, wherein a rate adapter is used according to this invention;

FIG. 6 is an exemplary block diagram of an onboard mobile terminal server according to an embodiment of this invention;

FIG. 7 is an exemplary block diagram of a ground earth station according to an embodiment of this invention;

FIG. 8 illustrates a rate adapting technique which converts an 8 kbps GSM signal into a 9.6 kbps signal for transmission to the satellite according to this invention;

FIG. 9 is an exemplary flowchart outlining a communication method from an onboard cell phone to a terrestrial cell phone according to this invention; and

FIG. 10 is an exemplary flowchart outlining a communication method from a terrestrial cell phone to an onboard cell phone according to this invention.

### DETAILED DESCRIPTION OF EXEMPLARY EMBODIMENTS

The following detailed description of various exemplary embodiments of a mobile platform communications system according to this invention refers to one specific type of mobile platform communications system, an airborne mobile platform communications system, for the sake of clarity. However, it should be appreciated that the principles of this invention, as outlined and/or discussed herein, can be equally applied to any known or later-developed mobile platform communications system and mobile devices, such as, for example, maritime and terrestrial mobile devices, such as ships, boats, buses, trains, trucks, and the like, other than an airborne mobile platform communications system as specifically discussed herein.

Furthermore, for clarity of explanation, an exemplary embodiment is described which pertains to a cell phone using the Global Speciale Mobile (GSM) as the cell phone standard. However, it should be appreciated that GSM is only exemplary, and that other standards, such as IS-36 and Japanese Digital Cellular (JDC) may also be used to practice this invention. Furthermore, the invention may be applicable to mobile terminals in general, rather than cell phones in particular. The systems and methods may be applicable to the transmission of data in general from the mobile terminal, rather than voice data in particular. Therefore, the exemplary embodiments described below should be regarded as illustrative and not limiting.

This invention pertains to systems and methods for providing a communications channel between a mobile terminal onboard an aircraft and a ground-based mobile terminal. In an exemplary embodiment of this invention, the communications channel eliminates two or more voice transcoding units, in order to simplify the transmission path, reduce delay, and improve the quality of the transmitted voice signal. In embodiments, this invention makes use of an existing method of switching out the transcoders (or codecs) in the AES and GES reducing delays and distortions between the mobile terminal onboard the aircraft and the ground-based mobile terminal or PSTN/ISDN phone.

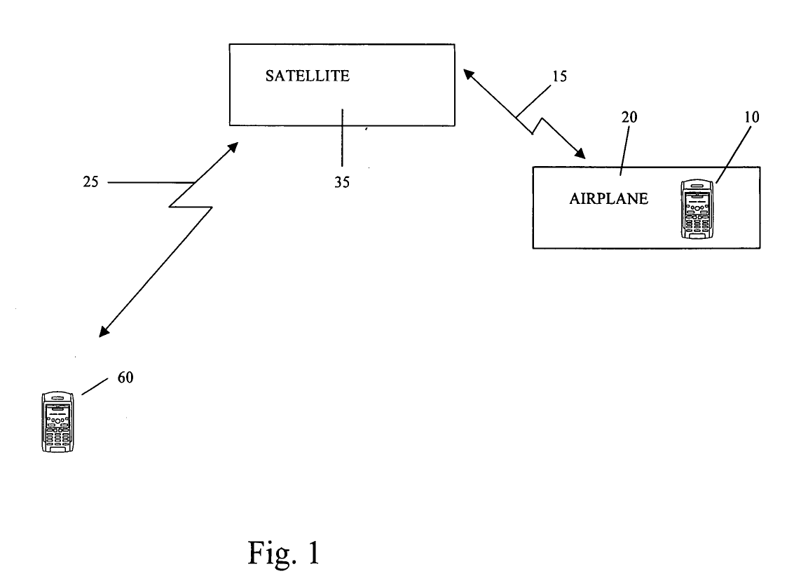

FIG. 1 is an exemplary block diagram of a communications path between an air-borne mobile terminal 10 and a ground-based terminal 60. The ground-based terminal 60 may either be a mobile terminal or a fixed terminal. The communications path may include an uplink portion 15 that handles communication from the mobile terminal 10 onboard the aircraft 20 to a satellite 35. The communications path may include a downlink portion 25 that handles communication between the satellite 35 and the ground-based terminal 60. Calls can be initiated either by the mobile terminal onboard the aircraft 10 or the ground-based terminal 60.

In various exemplary embodiments, the aircraft 20 may be at a higher altitude than the satellite 35. An example of an aircraft in such an embodiment is a spacecraft. Therefore, although the satellite 35 is typically at a higher altitude than both the aircraft 20 and the ground-based terminal 60, this is not necessarily the case. Thus, references herein to an uplink communications path and a downlink communications path are not intended to describe any necessary positional relationships, such as altitude, between the physical objects. Rather, references to an “uplink” or “downlink” are intended to be symbolic.

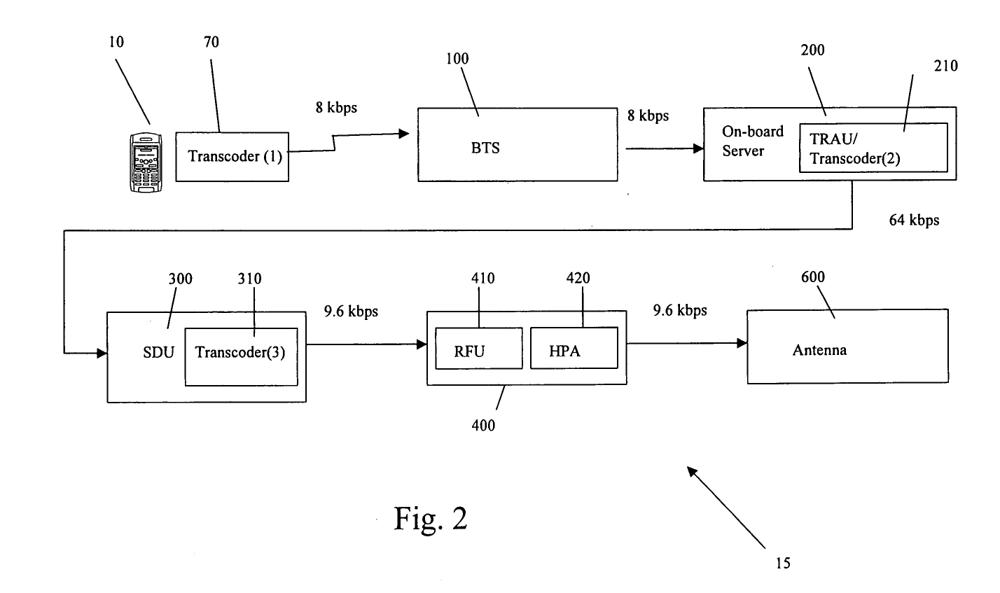

FIG. 2 shows an exemplary uplink portion 15 of the communications path of FIG. 1 in greater detail. The uplink portion from the mobile terminal 10 includes a first encode/decode transcoding module 70. It should be understood that the transcoding module 70 may be located internally to the mobile terminal 10. The mobile terminal 10 and transcoding module 70 may encode an analog voice signal into digital data, for example, according to GSM protocols. More specifically, the transcoding module 70 within the mobile terminal 10 will encode the analog voice signal (previously digitally encoded into a 13 bit uniform pulse code modulation (PCM) signal) into 20 millisecond (ms) samples, each of which is encoded as 260 bits, giving a total bit rate of 13 kbps (kilobits per second). This is full-rate speech encoding according to GSM format. Recently, an enhanced full-rate (EFR) speech coding algorithm has been implemented by some North American GSM operators using an enhanced transcoding module 70. This is intended to provide improved speech quality using a 12.2 kbps bit rate. Alternatively, the transcoding module 70 can encode the samples in a half rate format by encoding each sample as 112 bits, yielding a half-rate format data rate of 5.6 kbps. Therefore, the transcoding module 70 can encode the voice data into a data stream at a data rate of 5.6 kbps or 12.2/13 kbps, depending on the mode in which the mobile terminal is operating. The GSM specification additionally controls the transcoders via additional in-band signaling, which increases the overall data rate to 8 kbps and 16 kbps for half rate and full rate/enhanced full rate, respectively. The mobile terminal 10 then encodes the signal on a radio frequency carrier wave, and transmits the signal wirelessly to a base transceiver station 100.

The encoded voice signal is received by the base transceiver station 100, which transforms the radio frequency signal into electrical impulses. The base transceiver station 100 transmits the electrical impulses to a satellite data unit (SDU) 300 via an onboard server 200. The base transceiver station 100 houses the transmit and receive link for the mobile communication system. The base transceiver station 100 may also handle call control functions, such as call setup and terminate with the mobile terminal 10. Thus, the base transceiver station 100 may house the radio transceivers that define a cell and may handle the radio-link protocols with the mobile terminal 10. For example, each base transceiver station 100 can accommodate up to seven mobile terminals 10 at one time. However, the base transceiver station 100 does not alter the data rate of the encoded voice transmission.

In ordinary terrestrial GSM, the base transceiver station 100 communicates with a base station controller (BSC) across an Abis interface. The base station controller manages the radio resources for one or more base transceiver stations. The base station controller provides a connection between the mobile terminal and a mobile switching center (MSC), which is in communication with the public switched telephone network (PSTN).

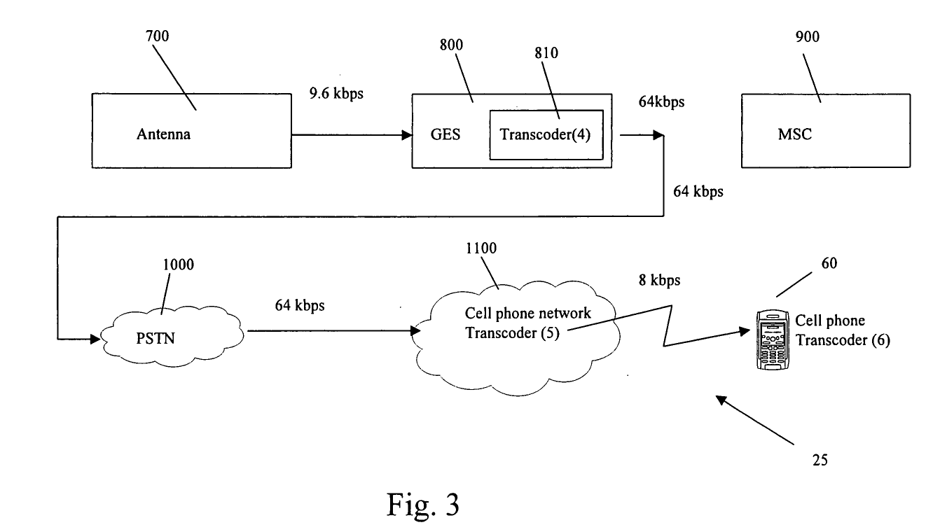

The base station controller on-board the aircraft accepts digitized voice data, and negotiates with the mobile terminal to determine the data format in which the mobile terminal will transmit the voice data. In the exemplary embodiment described, the base station controller negotiates with the mobile terminal 10 to transmit in half rate data format (e.g. 8 kbps throughput rate). In the airborne embodiment described, the base station controller functionality may be partially provided by the onboard server 200, and may be partially provided by the ground earth station 800, shown in FIG. 3.

The onboard server 200 may be connected to a satellite data unit 300 (SDU) by a CEPT E1 line. The E1 (or E-1) is a European digital transmission format devised by the International Telecommunications Union-Teleservices (ITU-TS) and given the name by the Conference of European Postal and Telecommunication Administration (CEPT). E1 is the European equivalent of the North American T-carrier system format, for example, the T-1 format operating at 1.544 million bits per second, used in North American telecommunications. E2 through E5 are carriers in increasing multiples of the E1 format.

The E1 signal format carries data at a rate of 2.048 million bits per second and can carry 32 channels of 64 kbps each. E1 therefore operates at a somewhat higher data rate than T-1. E1 and T-1 can be interconnected for international use.

Each 64 kbps digital data channel carries data encoded from analog voice according to the μlaw format. The μlaw format is a pulse code modulating (PCM) format used by most telephone companies in North America. The flaw format has an 8 kHz sampling rate with 8-bits of data per sample. This requires a serial transmission speed of 64000 bits per second. The μlaw format is described in Comite Consultatif International Telephonique et Telegraphique (CCITT) recommendation G.711. Formats like the μlaw format take advantage of certain types of sound by sampling the analog sound wave and quantizing it into 256 different levels. The μlaw format differs from standard A/D conversion techniques in that the steps defined by the 256 quantizing levels are not uniform. This allows a wide range of speech amplitudes with the same signal-to-noise ratio.

Returning to FIG. 2, the onboard server 200 executes software that manages the connection between the base transceiver station 100 and the satellite data unit 300. A typical satellite data unit 300 usable with this invention will meet the requirements of the Inmarsat Aero SDM and/or ARINC 741, e.g. the aforementioned satellite transceiver unit SAT-906, manufactured by Rockwell Collins. This device, or a similar satellite data unit manufactured by other manufacturers, is installed on over 80+% of the commercial long-haul airliner presently and also other general aviation aircraft. As the input line to the satellite data unit 300 is an E1 line, the satellite data unit 300 is configured to accept data at 64 kbps. The onboard server 200 therefore would be required to transcode the voice signal encoded by transcoder 70 at 8 or 16 kbps to μlaw 64 kbps, using a second transcoder 210, which is known in GSM as a transcoding rate adapter unit (TRAU) codec 210. The transcoding is the reverse process of the encode/decode performed by transcoder 70, which analyzes the data content of each segment of the encoded voice 8/16 kbps, and regenerates the PCM signal conforming to the μlaw 64 kbps format.

The satellite data unit 300 performs a third transcoding operation on the signal using a third transcoder 310, converting the signal from the μlaw 64 kbps format to a 9.6 kbps format for transmission over the satellite link. The 9.6 kbps data rate is the Aero H standard satellite communications format, as implemented and defined by the Aero SDM, for example, from Inmarsat of London, England in its satellites and satellite transceiver equipment for aeronautical use. From the satellite data unit 300, the 9.6 kbps signal is sent to a high gain antenna subsystem 400, via a radio frequency unit (RFU) 410 and a high power amplifier (HPA) 420, in the uplink path. The RFU 410 may encode the data on a radio frequency signal and the HPA 420 amplifies the signal for transmission. The data encoded at 9.6 kbps is then transmitted to a satellite antenna 600 for transmission to the satellite 35.

FIG. 3 shows a downlink portion 25 of the communications path in greater detail. The satellite 35 relays the 9.6 kbps signal via an antenna 700 to a ground earth station 800, which includes a fourth transcoding process is carried out by transcoder 810. The GES transcoder 810 converts the 9.6 kbps encoded voice sent over SATCOM signal back into standard μlaw 64K which can be routed directly into the PSTN, bypassing the mobile switching center (MSC) 900, as the TRAU for GSM was implemented in the on-board server of the aircraft.

The 64 kbps signal is transmitted to the public switched telephone network (PSTN) 1000, and then to the cell phone network 1100. In the cell phone network 1100, the encoded voice signal would be transcoded back into a GSM standard voice encoded data rate by a fifth transcoder before being transmitted by radio waves to the mobile terminal 60 The mobile terminal 60 then performs the final transformation into an analog voice signal which is reproduced by a speaker in the mobile terminal 60.

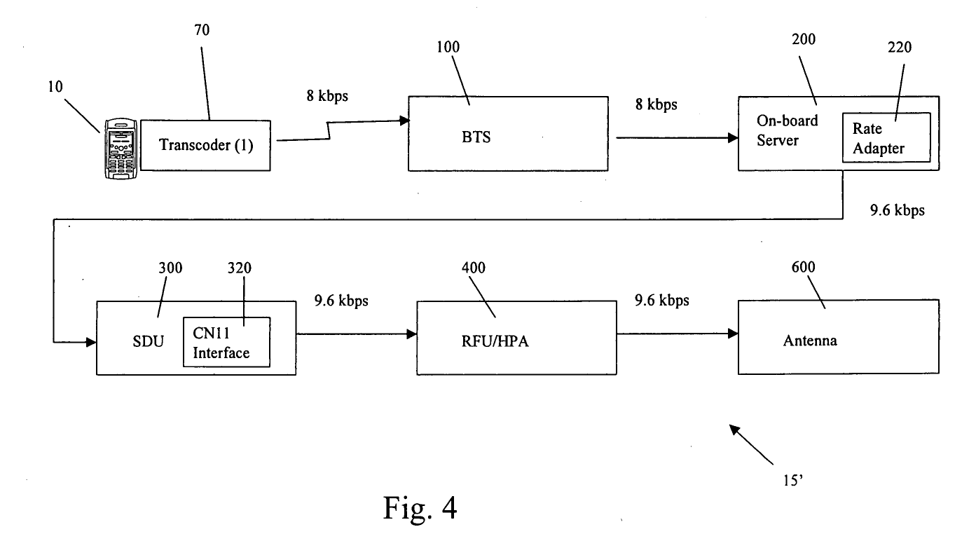

FIG. 4 shows an alternative embodiment of an uplink portion 15′. This alternative embodiment makes use of a feature installed on satellite data units which disables the third and fourth transcoders 310 in the satellite data unit 300 and 810 in the GES 800. The ability to switch out the transcoders is described in Inmarsat Change Note 11 (CN11). Therefore, the satellite data unit 300 can operate in a mode in which the signal is transmitted transparently through the unit such that no transcoding of the data is performed.

Ordinarily, the CN11 mode is used to transmit voice data which has already been encrypted by the mobile terminal. Because it is already encrypted, the SDU does not need to encode the digital voice data, but instead sends it transparently without manipulating the data, to the high gain antenna subsystem 400. This invention takes advantage of this previously existing feature to reduce the number of transcoder transformations of the signal for transmission over the satellite link and reduce the processing complexity in the on-board server 200.

According to this embodiment, the base station controller, for example, located in the onboard server 200, requests the mobile terminal 10 to transmit in the half rate (8 kbps) format, rather than the full rate or enhanced full rate (16 kbps) format. The onboard server 200 includes a rate adapter unit 220, instead of the second transcoding unit 210. This rate adapter unit 220 adapts the 8 kbps data signal into a 9.6 kbps signal, for example by padding the 8 kbps signal with padding characters, which increases the data rate to the desired 9.6 kbps. The 9.6 kbps data rate signal is then transmitted to the satellite data unit 300 compliant with CN11, instead of the third transcoder unit 310. The data is then transmitted transparently (i.e., without transcoding) through the satellite data unit 300. Therefore, the data signal is supplied to the high gain antenna subsystem 400 at the expected 9.6 kbps data rate. The signal then proceeds through the high gain antenna subsystem 400 as discussed above, being encoded on an RF carrier wave by the RFU 410, and amplified by the high power amplifier 420, before being transmitted to the satellite antenna 600.

The term “rate adapter” as used herein should be distinguished from the term “transcoding rate adapter unit” (TRAU). A rate adapter is a simple data processing device which converts data at a first data rate to data at a second data rate, simply by adding or removing padding characters. In contrast, a transcoding rate adapter unit (TRAU) is a digital signal processing device that analyzes the data content of a sequence of data at the first data rate, and maps the data content into a second sequence of data at the second data rate. The mapping may be a mathematical transformation from the sequence at the first data rate to the sequence at the second data rate, or may be performed by consulting a lookup table that maps an input sequence to a particular output sequence.

By using the rate adapter 220 in place of the TRAU 210, the onboard server 200 is relieved of having to provide complex signal processing functionality. Therefore, the onboard server 200 can use simple off-the-shelf data processing equipment such as Intel Pentium®-based processing, rather than expensive and dedicated signal processing equipment. Furthermore, because each voice channel would require its own TRAU, the cost and complexity of the onboard server 200 may be even further reduced in the case of multiple voice channels.

Furthermore, there may also be situations in which the data signal transmitted to the rate adapter 220 already has additional padding bits added to the signal, such that the data rate is in excess of 9.6 kbps. In this case, the rate adapter unit 220 removes the additional bits to recover a 9.6 kbps signal expected by the satellite data unit 300.

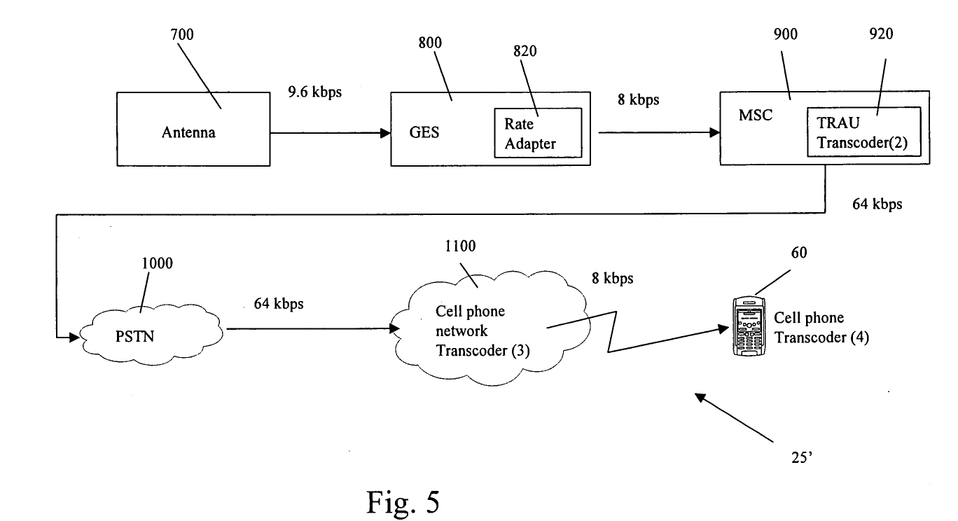

FIG. 5 shows an exemplary downlink path 25′ that may be used in conjunction with the uplink path 15′ of FIG. 4. The 9.6 kbps encoded data is received from the satellite 35 by the earth-based antenna 700. The signal is then transmitted to the ground-earth station (GES) 800 where the 9.6 kbps signal is rate adapted to the GSM standard 8 kbps signal by a rate adapter 820. The rate adapter 820 recovers the 8 kbps signal by removing the extra padding bits which were inserted by the rate adapter 220 in the uplink channel of FIG. 4. The rate adapter 820 is designed with respect to the rate adapter 220 in the onboard server 200 of FIG. 4, whereas the rate adapter 810 of FIG. 3 is designed with respect to a TRAU, such as TRAU 210 in the onboard server 200 of FIG. 2. Since the rate adapter 220 of the onboard server 200 of FIG. 4 only padded the 8 kbps data rate to achieve a 9.6 kbps data rate, the rate adapter 820 of the GES 200 simply removes the added bits from the signal.

The 8 kbps signal is then transmitted to the mobile switching center (MSC) 900, which further includes a second TRAU transcoder 920. The digital signal is transcoded into PCM μlaw 64 kbps standard format, and transmitted to the public switched telephone network 1000.

The PSTN 1000 then transmits the μlaw data signal to the cell phone network 1100. In the cell phone network, a third transcoder transcodes the μlaw 64 kbps data signal into the 8 kbps GSM standard data rate, which is then sent by radio frequency transmission to the individual mobile terminals 60. Each mobile terminal then returns the digital signal data into analog voice signal which is reproduced by the speakers in the mobile terminal 60.

Advantageously, the downlink path 25′ illustrated in FIG. 5 may include only two transcoders, and the uplink path 15′ illustrated in FIG. 4 may include only one transcoder. Therefore, the uplink path 15′ and downlink path 25′ of FIGS. 4 and 5 have two fewer transcoders than the uplink path 15 and downlink path 25 of FIGS. 2 and 3, resulting in better voice quality, decreased delay in the mobile terminal communications, and lower cost and complexity of the onboard server 200.

Communications can also originate from the terrestrial mobile terminal, with the onboard mobile terminal as the destination terminal. In this reverse situation, the task of rate adapting the 8 kbps data rate into the satellite communications data rate of 9.6 kbps is performed by the second rate adapter 820, and the first rate adapter 220 removes the bits added by the rate adapter 820. Therefore, to communicate in the reverse direction (from terrestrial mobile terminal to the onboard mobile terminal), the communications channel looks similar to that shown in FIGS. 4 and 5, only with the direction of the arrows reversed, and with the second rate adapter and first rate adapter exchanging rate adapting functions. It should be understood from the above discussion that in either direction of communication, from the onboard mobile terminal to the ground-based mobile terminal, or from the ground-based mobile terminal to the onboard mobile terminal, the CN11 secure telephone mode for the satellite data unit 300 may be enabled, in order for the data stream to pass transparently through the satellite data unit 300.

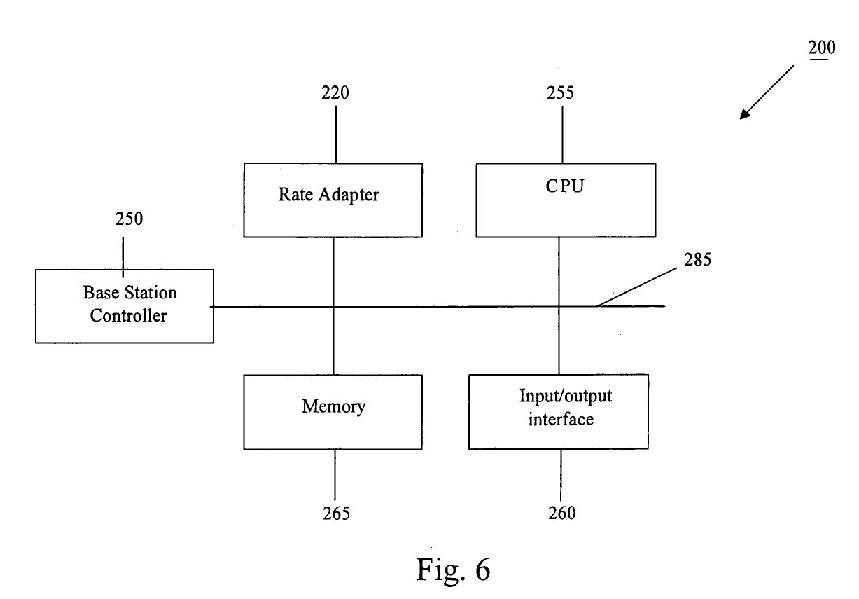

FIG. 6 illustrates in greater detail an exemplary embodiment of the onboard server 200 according to this invention. The onboard server 200 may include a CPU 255, an input/output interface 260, a memory 265, a rate adapter 220, and a base station controller 250. The above components may be coupled together, for example, via a bus 285. While the onboard server 200 is illustrated using a bus architecture diagram, any other type of hardware and/or software configuration may be used. For example, application specific integrated circuits (ASICs) may be used to implement one or more of the components, or a computer program that executes in the CPU 255 may be used to perform one or more of the functions of the onboard server 200.

The input/output interface 260 may receive the 8 kbps data signal from the base transceiver station 100, under the control of the CPU 255. The memory 265 may store a list of padding characters or sequences with which the rate adapter 220 will pad the data signal received by the input/output interface 260. The padding characters could be, for example, all “1's” or all “0's”; however, the padding characters may also be chosen to have a defined sequence of transitions, so as not to disrupt the functioning of a timing mechanism or clock used to time and detect the data. Such timing mechanisms may include, for example, phase locked loops which rely on the occurrence of data transitions at particular intervals, in order to update the phase of the data clock. Alternatively, the rate adapter may consult a lookup table stored in memory 265 which relates an input data string at 8 kbps and to an output data string at 9.6 kbps. The rate adapter 220 therefore generates the rate adapted signal at 9.6 kbps from the 8 kbps signal received by the input/output interface 260. The input/output interface 260 then outputs the rate adapted signal to the satellite data unit 300.

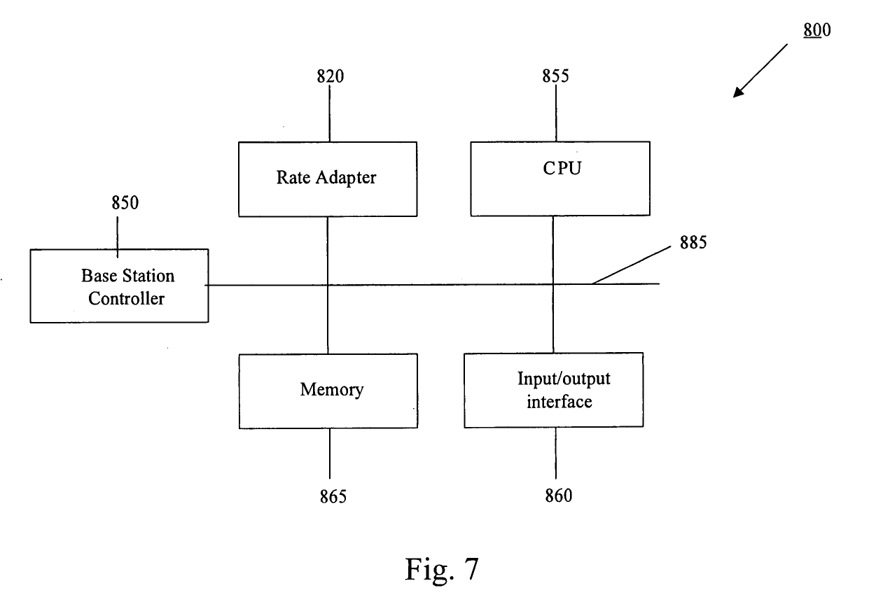

FIG. 7 illustrates in greater detail an exemplary embodiment of the ground earth station 800 according to this invention. The ground earth station 800 may include a CPU 855, an input/output interface 860, a memory 865, a rate adapter 820, and a base station controller 850. The above components may be coupled together, for example, via a bus 885. While the ground earth station 800 is illustrated using a bus architecture diagram, any other type of hardware and/or software configuration may be used. For example, application specific integrated circuits (ASICs) may be used to implement one or more of the components, or a computer program that executes in the CPU 855 to perform one or more of the functions of the ground earth station 800.

The input/output interface 860 may receive the 9.6 kbps data signal from the antenna unit 700 through the input/output interface 860, under the control of the CPU 855. The memory 865 may store a list of padding characters which the rate adapter 820 will remove from the data signal received by the input/output interface 860. Alternatively, the rate adapter may consult a lookup table stored in memory which relates an input data string at 9.6 kbps and to an output data string at 8 kbps. The rate adapter 820 therefore generates the rate adapted signal at 8 kbps from the 9.6 kbps signal received by the input/output interface 860. The input/output interface 860 then outputs the rate adapted signal to the mobile switching center (MSC) 900.

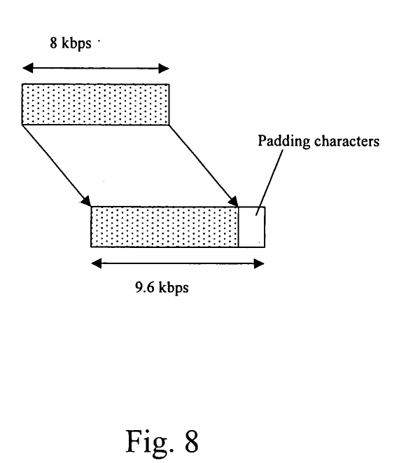

FIG. 8 shows the structure and format of the 8 kbps data which is rate adapted into a 9.6 kbps data rate. In this case, the unaltered 8 kbps data is simply time compressed into the front end of a 9.6 kbps frame, and the remainder of the frame is padded with padding characters to increase the data in a one second frame to 9.6 kbps. In alternative embodiments, the padding characters can be interspersed throughout the original 8 kbps of data, or loaded into the front end of the 9.6 kbps time frame.

In various exemplary embodiments, the onboard server 200 may be embodied as a plurality of functions rather than a single function or apparatus as shown in FIGS. 2 and 4. Therefore, the functionality of the onboard server 200 in such exemplary embodiments may be provided in a single housing or enclosure, within discrete housings or enclosures, or within a combination of housings.

It should be appreciated that, in various exemplary embodiments, the onboard server 200 and ground earth station 800 can be implemented as software executing on a programmed general purpose computer. Likewise, the onboard server 200 and ground earth station 800 can also be implemented on a suitably equipped computer, a programmed microprocessor or microcontroller and peripheral integrated circuit elements, an ASIC or other integrated circuit, a digital signal processor (DSP), a hardwired electronic or logic circuit, such as a discrete element circuit, a programmable logic device, such as a PLD, PLA, FPGA or PAL, or the like. In general, any device that is capable of implementing the functionality disclosed herein can be used to implement the onboard server 200 and ground earth station 800. Each of the various signal lines outlined above in FIGS. 2-5 connecting the various modules and the like can be direct signal line connections or can be software connections implemented using an implication programming interface or the like. It should be appreciated that any appropriate hardware, firmware or software elements or data structures can be used to implement one or more of the various modules and/or signal lines outlined above with respect to FIGS. 2-5.

It should be understood that each of the elements described above may comprise circuits, routines, applications, modules or the like, and may be implemented as software that is stored on a computer-readable medium and that is executable on a programmed general purpose computer, a programmed special purpose computer, a programmed microprocessor, a programmed digital signal processor or the like. Such a computer-readable medium includes using a carrier wave or the like to provide the software instructions to a processing device. It should also be understood that each of the circuits, routines, applications, modules or the like may be implemented as portions of a suitably programmed general purpose computer. Alternatively, each of the circuits, routines, applications, modules or the like may be implemented as physically distinct hardware circuits within an ASIC, using a digital signal processor DSP, using an FPGA, a PLD, a PLA and/or a PAL, or using discrete logic elements or discrete circuit elements. The particular form of the circuits, routines, applications, modules or the like is a design choice. It should be appreciated that the circuits, routines, applications, modules or the like do not need to be of the same design.

The terms “circuit”, “routine”, “application”, and/or “module” can refer to, for example, any appropriately-designed circuit, a sequence of instructions, a sequence of instructions organized with any programmed procedure or programmed function, and/or a sequence of instructions organized within programmed processes executing in one or more computers. Such circuits, routines, applications, modules, or the like, can also be implemented directly in circuitry that performs a procedure. Further, the data processing described with respect to FIGS. 2-5 can be performed by a computer executing one or more appropriate programs, by special purpose hardware designed to perform the method, or any combination of such hardware, firmware and software elements.

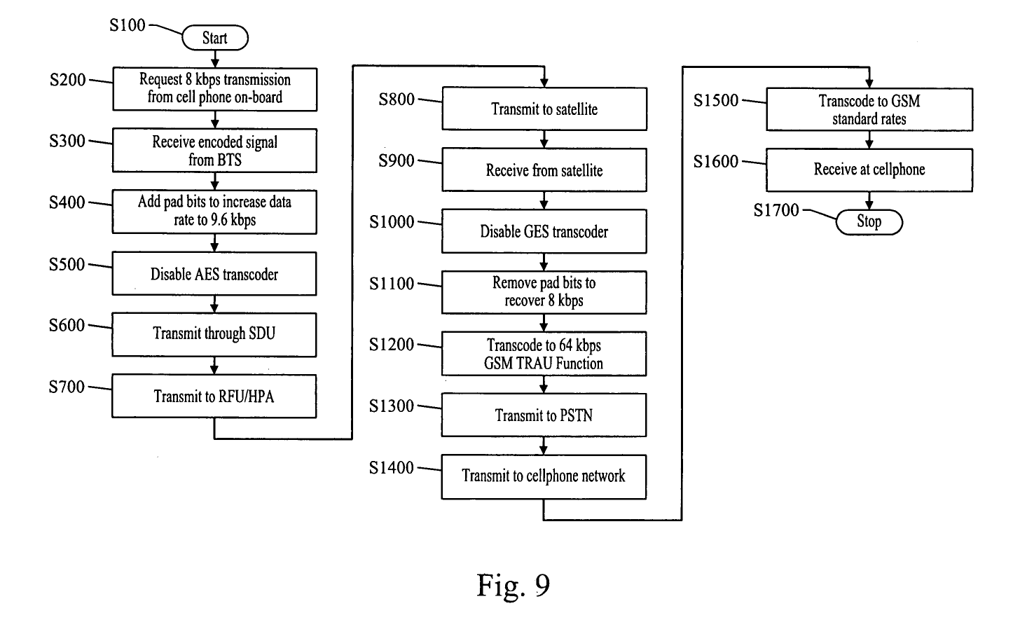

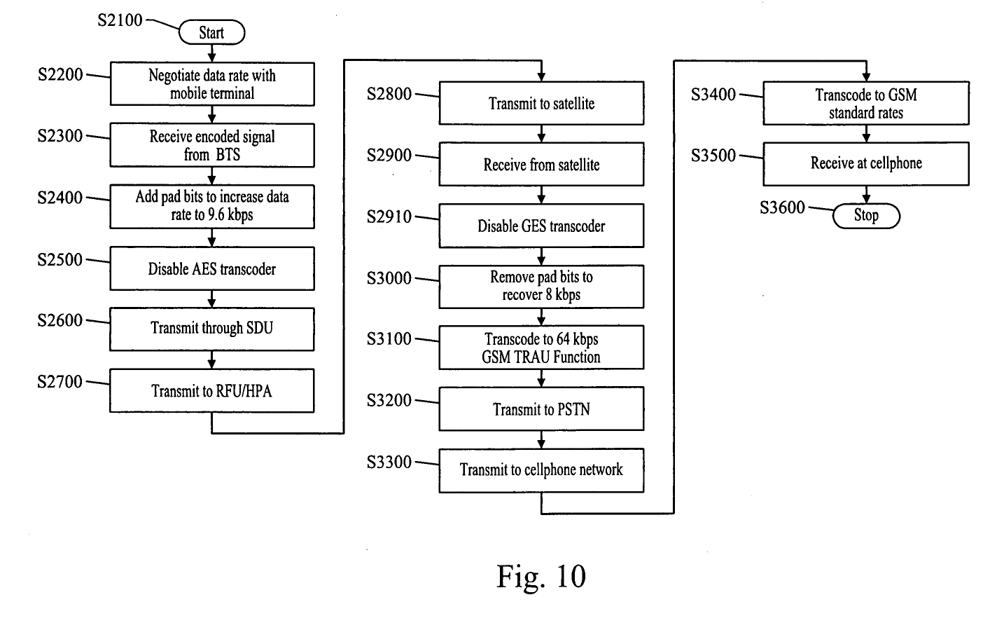

Although the previous description has been given with reference to a hardware embodiment, as mentioned above, the method may also be implemented as software executing on a microprocessor. In this case, each of the steps of the method may be carried out by a programmed microprocessor or ASIC, or it may be performed by some combination of hardware and software executing the steps of the method. The overall process exemplified by FIGS. 4 and 5 can be performed by a microprocessor executing the exemplary steps shown in FIGS. 9 and 10.

FIG. 9 is a flow diagram outlining an exemplary method of communicating via a mobile platform communications system using mobile terminals onboard an aircraft according to this invention. The flow diagram of FIG. 9 illustrates the case in which the data flows from the onboard mobile terminal to the ground-based mobile terminal.

The method starts in step S100, and continues to step S200 where a request is made for the mobile terminal to transmit voice data in the 8 kbps GSM format. In step S300, the encoded signal is received from the base transceiver station. In step S400, pad characters are added to the 8 kbps signal to generate a signal at a 9.6 kbps data rate. In step S500, the satellite data unit (SDU) transcoder is disabled, so that the 9.6 kbps signal is transmitted transparently through the SDU in step S600. In step S700, the data is transmitted to the radio frequency and high gain amplifier unit. In step S800, the data is transmitted to the satellite. In step S900, the data is received from the satellite and in step S1000 the GES transcoder is disabled. In step S100, the pad bits are removed to recover the data signal at 8 kbps. In step S1200, the data is transcoded onto 64 kbps μlaw format. In step S1300, the data is transmitted to the public switched telephone network (PSTN). In step S1400, the data is transmitted to the mobile terminal network. In step S1500, the data is transcoded back into the GSM standard (e.g. HR/FR/EFR etc). In step S1600, the data is received by the mobile terminal. In step S1700, the process ends.

It should be appreciated that the method shown in FIG. 9 is exemplary only, and that the steps need not be performed in the precise order shown in FIG. 9. It should also be clear to one skilled in the art that a similar figure can be drawn, based on the above description, with the data flowing in the opposite direction, which would illustrate the case in which the data flows from the ground-based mobile terminal to the onboard mobile terminal.

This procedure is illustrated by the flow chart of FIG. 10, which is an exemplary embodiment of a method for communicating from a ground-based mobile terminal to an onboard mobile terminal. The method begins in step S2100, and proceeds to step S2200, wherein a request is made from the BTS for the mobile terminal to send the encoded voice at one of the GSM voice data rates. In step S2300, the encoded data is received from the base transceiver station. In step S2400, the data is transmitted to the cell phone network, where it is transcoded into μlaw 64 kbps format in step S2500. The transcoded data is then transmitted to the public switched telephone network in step S2600. In step S2700, the data is transmitted to a mobile switching center. In step S2800, the voice data is transcoded to 8 kbps. In step S2900, the 8 kbps voice data is rate adapted to the satellite data rate of 9.6 kbps, S2910 the GES transcoder is disabled and the data is transmitted to the satellite in step S3000.

In step S3100, the data is received from the satellite. After disabling the satellite data unit transcoder in step S3200, the data is rate adapted to 8 kbps in step S3300. The data is transmitted to the base transceiver station in step S3400, and then received by the onboard mobile terminal in step S3500. The process ends in step S3600.

The mobile platform communications system was described primarily with air travel in mind. However, the mobile platform communications system also operates when the aircraft is in motion on the ground, such as when the aircraft is taxiing on the runway before takeoff or after landing. In the same manner, the mobile platform communications system can operate when the aircraft is stationary on the ground, such as after boarding but prior to departure, and while awaiting authorization to take off. Whether the aircraft is in motion or stationary, or in the air or on the ground, the mobile platform communications system operates in the same manner.

Similarly, the mobile platform communications system can be installed on other forms of transportation, such as maritime transportation vehicles, and other forms of terrestrial transport, such as trains, buses, trucks, and the like, beyond the airborne mobile platform communications systems discussed herein.

While this invention has been described in conjunction with the exemplary embodiments outlined above, many alternatives, modifications and variations are contemplated. For example, the invention has been described with reference to an application within the airline industry. Accordingly, the exemplary embodiments of the invention as set forth above are intended to be illustrative, not limiting. Various changes may be made without departing from the spirit and scope of the invention.

1. An apparatus for transmitting data via satellite from a mobile terminal generating data at an original data rate to a destination terminal, comprising:
a first rate adapter which adapts the original data rate to a second data transmission rate; and
a second rate adapter which recovers the original data rate from the second data rate.

2. The apparatus of claim 1, wherein the data is voice data generated by the mobile terminal.

3. The apparatus of claim 1, wherein the first rate adapter adapts the original data rate to a second data rate by adding padding characters to a data sequence in the original data rate.

4. The apparatus of claim 3, wherein the padding characters are added to an end of the data sequence in the original data rate.

5. The apparatus of claim 3, wherein the second rate adapter recovers the original data rate by removing the added padding characters from the data sequence in the second data rate.

6. The apparatus of claim 1, further comprising:
a satellite data unit that receives the voice data at the second date rate and transmits the voice data to a high gain antenna unit.

7. The apparatus of claim 6, wherein the high gain antenna unit receives the voice data at the second data rate from the satellite data unit and encodes the voice data on a radio frequency carrier wave for transmission to an orbiting satellite.

8. The apparatus of claim 6, further comprising:
a ground earth station that receives the voice data at the second data rate from a satellite and adapts the second data rate back to the original data rate using the second rate adapter.

9. The apparatus of claim 8, further comprising:
a mobile switching center including a transcoding rate adapter unit that transcodes the voice data received from the ground-earth station from the original data rate into a μlaw format for transmission over a public switched telephone network.

10. The apparatus of claim 6, further comprising:
a secure telephone module that disables an encoding/decoding device in the satellite data unit.

11. The apparatus of claim 8, further comprising:
a secure telephone module that enables the second rate adapter in the ground earth station.

12. The apparatus of claim 1, wherein the second data rate is a satellite communications data rate for transmitting data to and from an orbiting satellite.

13. The apparatus of claim 1, wherein the original data rate is a half rate format GSM standard communications data rate.

14. A method for communicating from a mobile terminal to another mobile terminal via satellite, comprising:
encoding digital data at an original data rate;
rate adapting the original data rate to a second data rate;
transmitting digital voice data at the second data rate to a satellite reception station via satellite; and
rate adapting the second data rate back to the original data rate.

15. The method of claim 14, wherein the digital data is digitized voice data.

16. The method of claim 14, further comprising:
rate adapting the original data rate to the second data rate by at least one of adding and removing padding characters.

17. The method of claim 14, further comprising:
rate adapting the second data rate back into the original data rate by at least one of removing and adding padding characters.

18. The method of claim 14, further comprising:
transcoding the original data rate into a μlaw format; and
transmitting the transcoded data over a public switched telephone network.

19. The method of claim 18, further comprising:
transmitting the transcoded data over a terrestrial cell phone network.

20. The method of claim 14, further comprising:
setting a satellite data unit to a secure telephone mode such that an encode/decode device in the satellite data unit is disabled.

21. The method of claim 14, further comprising:
encoding the digital voice data at the second data rate onto an RF signal;
amplifying the RF signal; and
transmitting the RF signal to the satellite.

22. The method of claim 14, wherein the original data rate is a half rate GSM data rate, and the second data rate is a satellite communications data rate.

23. The method of claim 14, further comprising:
setting the satellite reception station to a secure telephone mode such that a second rate adapting device in the satellite reception station is enabled.

24. A computer-readable medium having computer-readable program code embodied therein, the computer-readable program code performing the method of claim 14.
